(19) United States
(12) Patent Application Publication
(10) Pub. No.: US 2002/0031213 A1
(43) Pub. Date: Mar. 14, 2002

(54) Telephone exchange system with multiple lifelines

(76) Inventor: Yean-Ching Miao, Taipei (TW)

Correspondence Address: BIRCH STEWART KOLASCH & BIRCH, PO BOX 747, FALLS CHURCH, VA, 22040-0747, US

(21) Appl. No.: 09/885,099

(22) Filed: Jun. 21, 2001

(30) Foreign Application Priority Data
Sep. 11, 2000 (TW) 89118597

(51) Int. Cl. H04M 7/00; H04M 1/00

(52) U.S. Cl. 379/219; 379/399.01

(57) ABSTRACT

A telephone exchange system with multiple lifelines, including a telephone exchange device, a plurality of lifelines, a plurality of user line groups containing a plurality of user lines and a plurality of switch devices. The first end of each switch device connects to a corresponding user line and the second end switches between the telephone exchange device and a lifeline. The user lines of the same user line group are connected to the same lifeline in parallel through the second end of the corresponding switch device.

### BACKGROUND OF THE INVENTION

1. Field of Invention

The invention relates to a telephone exchange system with multiple lifelines. Related Art Usual telephone exchange systems, whether using a conventional PBX (Private Branch Exchange) to link to a PSTN (Public Service Telephone Network) or an ITG (Internet Telephony Gateway) to connect to a digital network, need a power supply for normal operations. When a power outage happens, the telephone exchange system will not be able to operate, resulting in connection failure between user telephones and the telephone exchange system.

To prevent such situations from occurring, the telephone exchange system is usually installed with lifelines so that at least one telephone can connect to the system through the PSTN during a power failure. Referring to FIG. 1, which takes the telephone exchange system 1 using the ITG as an example, telephone devices 51, 52, 53 are first connected to the corresponding SLIC (Subscriber Line Interface Circuit) 111, 112, 113 and then to the ITG 12. The analogue voice signals are converted into digital voice signal capsules for transmission through a digital network. The telephone device 53 is installed with a switch device 13 before connecting to the SLIC 113. One end of the switch device 13 is connected to the telephone device 53 while the other end can switch between the SLIC 113 and the lifeline 20 connecting to the PSTN. Under normal circumstances, the switch device 13 connects the telephone device 53 and the corresponding SLIC 113. When the power fails, the switch device 13 switches to the lifeline 20 so that the telephone device 53 can directly connect to the PSTN via the lifeline 20. Therefore, not all telephone devices are disconnected when the ITG 12 cannot function due to a power failure.

Nevertheless, the above design still has the following disadvantages:

First, if there are very many telephone devices that connect to the telephone exchange system and are distributed in different areas or even different floors, thus keeping only one telephone device connected to the lifeline is very inconvenient.

Furthermore, the telephone device connecting to the lifeline is a specific telephone device. Therefore, when one connection line to the telephone exchange system is out of order, the above telephone exchange system cannot automatically switch the broken telephone line to the lifeline in order to avoid jammed phone lines.

### SUMMARY OF THE INVENTION

Pursuant to above problems, an object of the invention is to provide a telephone exchange system with multiple lifelines so that several telephone devices can still connect to the lifeline during a power failure.

Another object of the invention is to provide a telephone exchange system with multiple lifelines, which can temporarily switch any broken telephone line to the lifeline in an active way so as to avoid jammed phone lines.

To achieve the above objects, the disclosed telephone exchange system with multiple lifelines includes a telephone exchange device, a plurality of lifelines, a plurality of user line groups and a plurality of switch devices. Each user line group includes a plurality of user lines connecting to the telephone device. A first end of each of the switch devices connects to a corresponding user line while a second end switches between the telephone exchange device and a corresponding lifeline. The user lines of the same user line group are connected in parallel to the second end of the corresponding switch device, which then connects to the same lifeline.

### BRIEF DESCRIPTION OF THE DRAWINGS

The invention will become more fully understood from the detailed description given hereinbelow illustration only, and thus are not limitative of the invention, and wherein:

FIG. 1 is a schematic view showing a telephone exchange system in the prior art;

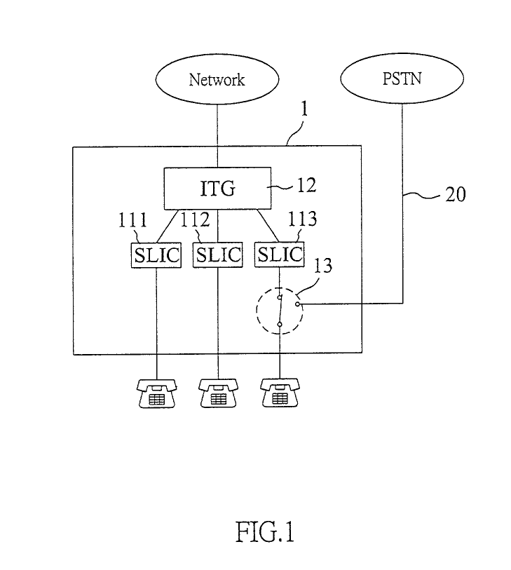

FIG. 2 is a schematic view showing a telephone exchange system according to a preferred embodiment of the invention;

FIG. 3 schematically illustrates an implementation of the disclosed telephone exchange system according to a preferred embodiment of the invention;

FIG. 4 schematically illustrates an implementation of the disclosed telephone exchange system according to the preferred embodiment of the invention; and

FIG. 5 schematically illustrates an implementation of the disclosed telephone exchange system according to another preferred embodiment of the invention.

In the various drawings, the same references relate to the same elements.

### DETAILED DESCRIPTION OF THE INVENTION

A preferred embodiment of the disclosed telephone exchange system with multiple lifelines will be apparent from the following detailed description, which proceeds with reference to the accompanying drawings, wherein the same references relate to the same elements.

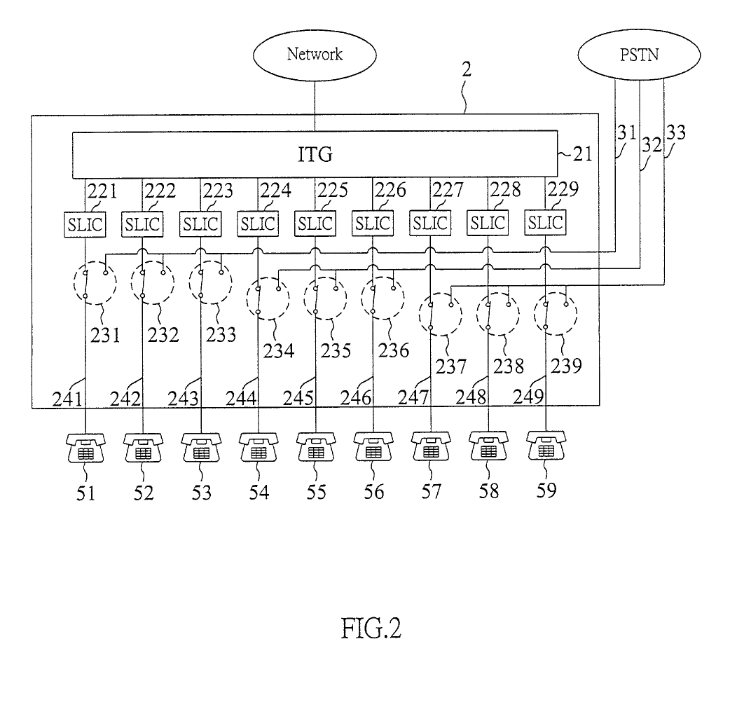

With reference to FIG. 2, the disclosed telephone exchange system 2 includes an ITG (Internet Telephony Gateway) 21 connecting externally to a digital network, nine SLICs 221 through 229, nine corresponding switch devices 231 through 239, nine user lines 241 through 249, and three lifelines 31, 32, 33. First ends of the switch devices 231 through 239 connect to the corresponding telephone devices 51 through 59 via the corresponding user lines 241 through 249. Their second ends switch between the corresponding SLIC and the lifeline. Through the telephone exchange system 2, analogue voice signals in the telephone devices 51 through 59 are converted into digital voice signal capsules so as to be transmitted over a usual digital network without going through a PSTN.

Under normal conditions, the switch devices 231 through 239 connect to the corresponding user lines and SLICs. For example, the switch device 231 connects to the user line 241 and the SLIC 221 and the switch device 235 connects to the user line 245 and the SLIC 225. Under unusual conditions, e.g. when the ITG 21 cannot function due to power failure, the switch devices 231 through 239 immediately switch to the corresponding user lines and lifelines. For example, when the power fails, the switch device 231 switches to the user line 241 and the lifeline 31, while the switch device 235 connects to the user line 245 and the lifeline 32.

In FIG. 2, the telephone devices are divided into three groups, namely a first telephone device group (containing the telephone devices 51, 52, 53), a second telephone device group (containing the telephone devices 54, 55, 56), and a third telephone device group (containing the telephone devices 57, 58, 59). The user lines between the telephone devices and the switches are also divided into three user line groups, namely a first user line group (containing the user lines 241, 242, 243), a second user line group (containing the user lines 244, 245, 246), and a third user line group (containing the user lines 247, 248, 249). The user lines in the same group are connected in parallel to the same lifeline through the corresponding switch device when the ITG 21 is broken. Explicitly, the user lines 241, 242, 243 in the first user line group are connected to the lifeline 31 by the switch devices 231, 232, 233; the user lines 244, 245, 246 in the second user line group are connected to the lifeline 32 by the switch devices 234, 235, 236; the user lines 247, 248, 249 in the third user line group are connected to the lifeline 33 by the switch devices 237, 238, 239.

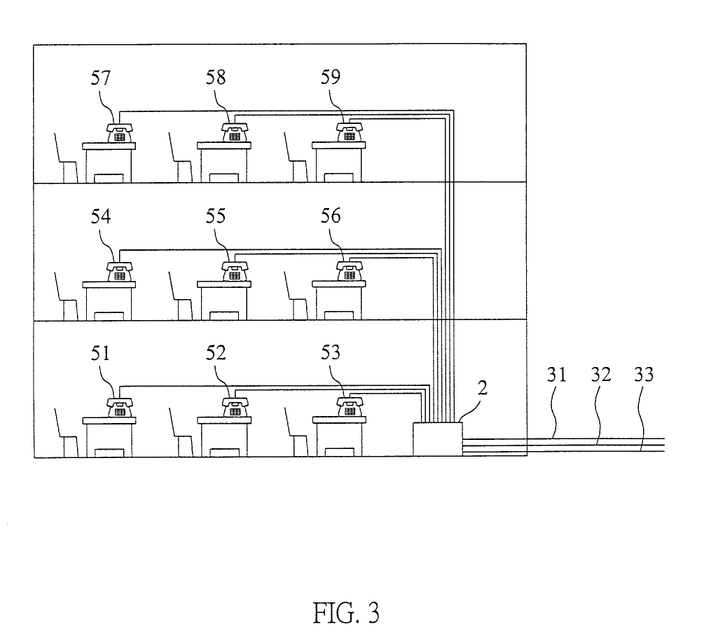

In accordance with the above design, when the ITG 21 is unable to function (such as during power failures or the connected digital network is broken), all connected telephone devices can be switched by the switch devices to connect to the corresponding lifelines . Therefore, each telephone device can be connected to a PSTN through the corresponding lifeline. As shown in FIG. 3, if, for example, the first telephone device group, the second telephone device group, and the third telephone device group are located on three different floors, only one telephone device on some floor can be connected to the PSTN via a lifeline in the prior art. According to the invention, each telephone device on each floor can be connected to the PSTN via the lifelines, rendering great convenience for the users.

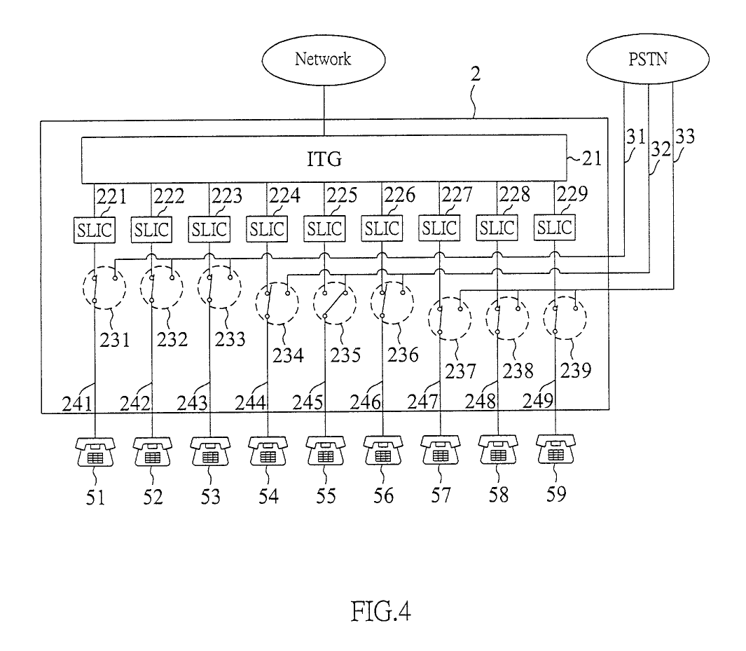

In addition, the disclosed telephone exchange system 2 can temporarily switch some telephone devices to the lifelines. As shown in FIG. 4, when any telephone device (e.g., the telephone device 55) cannot operate normally, it is probably because some internal circuit in the telephone exchange system 2 is out of order. Under these circumstances, the telephone device 55 is switched to a lifeline by the switch device 235 so that it can be temporarily connected to the PSTN. After the disordered circuit is repaired, the telephone device 55 is switched back to the ITG 21. This can greatly enhance the flexibility in the uses of the telephone exchange system 2 and the quality of service in maintenance.

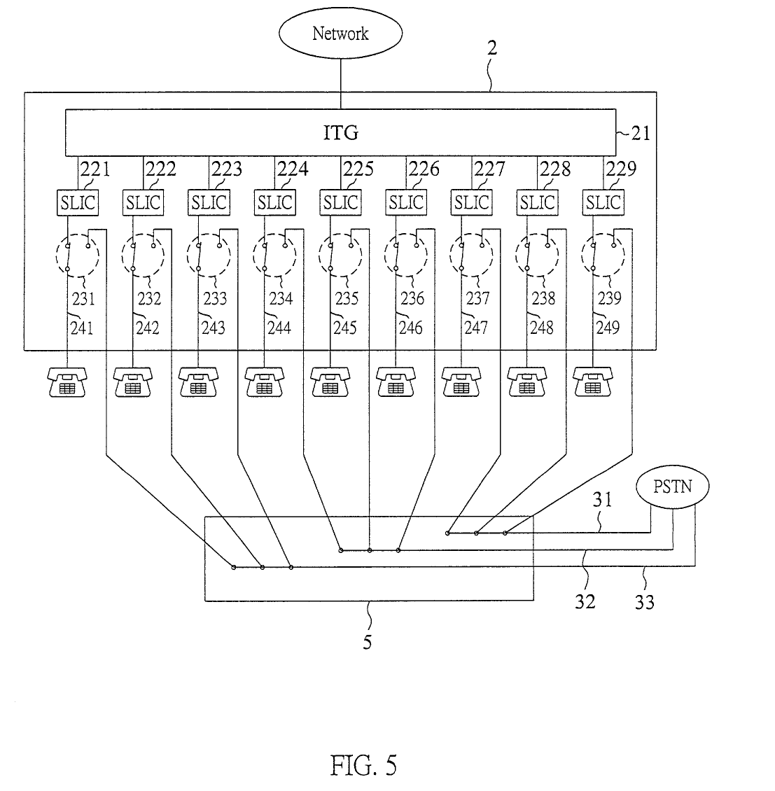

With reference to FIG. 5, the disclosed telephone exchange system 2 can extend the ends of the switch devices 231 through 239 that are to be linked to the lifelines 31 through 33 to a connection box 5 and then connect them in parallel. This can actively adjust the number of telephone devices in the same user line group of a lifeline. For example, in FIG. 5, the end of the switch device 233 to be connected with the lifeline 31 is switched to the lifeline 32 in the connection box 5. The first telephone device group now only contains the telephone devices 51, 52 while the second telephone device group contains the telephone devices 53, 54, 55, 56. This design can increase the flexibility of the disclosed telephone exchange system 2.

In accordance with the disclosed telephone exchange system with multiple lifelines, a plurality of connections between telephone devices and lifelines can be kept during an emergency condition. Therefore, it can greatly enhance the convenience of use.

In accordance with the disclosed telephone exchange system with multiple lifelines, a plurality of connections between telephone devices and lifelines can be kept during an emergency condition. Therefore, it can ensure the safety of the personnel during the emergency.

Since the disclosed telephone exchange system can temporarily switch potentially problematic telephone lines to lifelines immediately when any connection circuit of the telephone device is out of order, it can greatly enhance the flexibility in uses and quality of service in maintenance.

Certain variations would be apparent to those skilled in the art, which variations are considered within the spirit and scope of the claimed invention.

What is claimed is:

1. A telephone exchange system with multiple lifelines, which comprises:
a telephone exchange device;
a plurality of lifelines;
a plurality of user line groups, each of which contains at least one user line; and
a plurality of switch devices, whose first end connects to a corresponding user line and whose second end switches between the telephone exchange device and a corresponding lifeline.

2. The system of claim 1, wherein when there are more than two user lines in the user line group, the user lines are connected to the second end of the switch device in parallel and then to the same lifeline.

3. The system of claim 1, wherein the telephone exchange device contains an ITG (Internet Telephony Gateway).

4. The system of claim 1, wherein the telephone exchange device contains a PBX (Public Branch Exchange).

5. The system of claim 1, wherein the telephone exchange device further connects to a PSTN (Public Service Telephone Network).

6. The system of claim 1 further comprising a plurality of SLICs (Subscriber Line Interface Circuit), each of which connects to the telephone exchange device and the second end of the corresponding switch device.
